(19) United States
(12) Patent Application Publication
(10) Pub. No.: US 2004/0054752 A1
(43) Pub. Date: Mar. 18, 2004

(54) Fashion information server device and fashion information management method

(76) Inventors: Miho Takagi, Kanagawa (JP); Takeshi Muramoto, Kanagawa (JP); Takeshi Katano, Kanagawa (JP)

Correspondence Address: PEARNE & GORDON LLP, 1801 EAST 9TH STREET, SUITE 1200, CLEVELAND, OH, 44114-3108, US

(21) Appl. No.: 10/311,665

(22) PCT Filed: Feb. 14, 2002
(86) PCT No.: PCT/JP02/01253

(30) Foreign Application Priority Data
Mar. 23, 2001 (JP) 2001-86043

(51) Int. Cl. G06F 15/16

(52) U.S. Cl. 709/217

(57) ABSTRACT

The object of the invention is to integrate management of information on the user's own furnishings and furnishings information provided by apparel makers, shops, and magazines thereby easily obtaining and effectively providing furnishings-related information.

In the invention, on the network are provided a management server for managing furnishings-related information, an apparel maker database for storing information from apparel makers, a magazine database for storing information carried by magazines, a shop database for storing information from shops, and a personal database for storing information on the user's own furnishings and the user's personal information. It is possible to create coordination information where the user's own furnishings and information-provided furnishings are combined and user-tailored catalog information based on the provided information from apparel makers, shops and magazines and user information from each user, and browse such information on the user terminal.

### TECHNICAL FIELD

The present invention relates to a furnishings information server apparatus and a furnishings information management method for managing and effectively utilizing various information on furnishings by using information on the user's own furnishings and furnishings information provided by apparel makers, shops and books such as magazines.

### BACKGROUND OF THE INVENTION

Recently, network information technologies such as the Internet have developed and services whereby articles such as furnishings can be purchased via a network are in practical use. For example, the user can access a shop site on the network selling clothes, shoes and accessories and browse the articles and order and/or settle the purchase of the articles he/she likes.

In the related art system, the user wishing to obtain furnishings information accesses a server implemented for each provision source such as an apparel maker, store, and magazine, and browse the information he/she is interested in. This makes it rather difficult to look for the target information, or the user sometimes fails to find the target information. In this way, an access to desired information has been cumbersome.

The user cannot manage the information on the furnishings of the use's own. Thus the user happens to purchase an article that does not fit with the furnishings the user currently owns or purchase an article similar to what he/she owns now. This is wasteful to the user.

The furnishings information flows in one direction, from an information source to the user. Thus apparel makers and shops cannot obtain direct feedback information from the user including furnishings popular among the consumers and trend of the user's favorites.

The invention has been proposed in view of the aforementioned circumstances and aims at providing furnishings information server apparatus and a furnishings information management method whereby the user can easily obtain the information on the desired furnishings from a plurality of information sources by specifying the keyword of an item.

Another object of the invention is to provide furnishings information server apparatus and a furnishings information management method whereby the user can examine the coordination such as an arbitrary combination of furnishings whose information is provided by apparel makers, shops and books or a combination of the user's own furnishings and furnishings whose information is provided.

Another object of the invention is to provide furnishings information server apparatus and a furnishings information management method whereby the user can manage the information on the currently owned furnishings of the user and the user's own personal information and obtain proper information in order to reduce failure in purchasing furnishings.

Another object of the invention is to provide furnishings information server apparatus and a furnishings information management method whereby the information provider can provide information customized as required on a per user's basis or propose coordination by acquiring the user's personal information, thereby allowing effective market analysis and sales promotion activities.

### DISCLOSURE OF THE INVENTION

First, the invention provides furnishings information server apparatus characterized in that the server apparatus comprises a provided information storage section for storing provided information including information on furnishings provided by at least one of the apparel maker supplying furnishings onto the market, shop selling furnishings, and book carrying information on furnishings, a user information storage section for storing user information including information on the user'sown furnishings, and an information management section for outputting furnishings-related information in response to a request from the user or information provider based on the provided information and the user information.

The invention also provides a furnishings information management method comprising a provided information storing step for storing provided information including information on furnishings provided by at least either apparel makers supplying furnishings onto the market, shops selling furnishings, and books carrying information on furnishings, a user information storing step for storing user information including information on the user's own furnishings, and an information management step for outputting furnishings-related information in response to a request from the user or information provider based on the provided information and the user information.

Second, the furnishings information server apparatus is characterized in that the user information has information on the user's own furnishings representing features of furnishings including at least one of the item name, color, shape, size and design group, as well as the images of the user's own furnishings.

Third, the furnishings information server apparatus is characterized in that the user information has personal information including at least one of the body shape, taste, age and furnishings purchase history of the user.

Fourth, the furnishings information server apparatus is characterized in that the provided information has provided furnishings information representing features of furnishings including at least one of the item name, color, shape, size and design group, as well as the images of the furnishings provided by the information provider.

Fifth, the furnishings information server apparatus is characterized in that the provided information further has furnishings purchase information including at least one of the price of the furnishings, furnishings supply source, stock state, and information such as catalogs from the information source provided by the information provider.

With this configuration, the user can easily obtain desired furnishings information from a plurality of information sources and obtain proper user-specific information by tailoring provided information based on the user information. The user can manage the information on the furnishings the user currently owns and the user's own personal information thereby obtaining proper information in order to reduce failure in purchasing furnishings. The information provider such as an apparel maker, shop, publisher of books such as magazines can provide information customized as required on a per user's basis or propose coordination by acquiring the user's personal information, thereby allowing effective market analysis and sales promotion activities.

Sixth, the furnishings information server apparatus is characterized in that the server apparatus creates, as the furnishings-related information, furnishings coordination information comprising a combination of information on the user's own furnishings in the user information, information on the furnishings provided by the information provided in the provided information and both information on the furnishings, and outputs the furnishings coordination information in response to a request from the user or information provider.

Seventh, the furnishings information server apparatus is characterized in that the server apparatus creates the coordination information by extracting and combining furnishings which fit the target user based on the personal information including the taste of the user.

Eighth, the furnishings information server apparatus is characterized in that the server apparatus variably creates the coordination information by using a combination of furnishings in accordance with the instruction input of the user or information provider.

Ninth, the furnishings information server apparatus is characterized in that the coordination information is created by extracting and combining furnishings from the provided information provided by a plurality of information providers.

With this configuration, the user can combine user's own furnishings and furnishings whose information is provided and furnishings from a plurality of information providers thus easily examining free and proper coordination of furnishings before purchasing or wearing the furnishings.

Tenth, the furnishings information server apparatus is characterized in that the server apparatus creates, as the furnishings-related information, catalog information related to furnishings in the provided information provided by the information provider and outputs the catalog information in response to a request from the user or information provider.

Eleventh, the furnishings information server apparatus is characterized in that the server apparatus creates the catalog information by extracting furnishings which fit the target user based on the personal information including the taste of the user.

Twelfth, the furnishings information server apparatus is characterized in that the server apparatus creates the catalog information by combining the provided information provided by a plurality of information providers.

With this configuration, it is possible to create preferable catalog information per user in accordance with personal information such as the user's own furnishings, taste, age and body shape, thereby providing the user with proper furnishings-related information.

Thirteenth, the furnishings information server apparatus is characterized in that the server apparatus comprises a purchase settlement section for performing settlement on the purchase of the corresponding furnishings in accordance with the instruction input from the user executed concerning the furnishings-related information.

The invention also provides a furnishings information management method characterized in that the method comprises a purchase settlement step for performing settlement on the purchase of the corresponding furnishings in accordance with the instruction input from the user executed concerning the furnishings-related information.

With this configuration, the user can easily obtain desired furnishings information by using a terminal connected via a network, as well as purchase without trouble the target furnishings whose information is provided.

Fourteenth, the furnishings information server apparatus is characterized in that the server apparatus creates, as the furnishings-related information, user characteristics information on the user's own furnishings or furnishings to be purchased based on the user information and outputs the user characteristics information to the information provider.

Fifteenth, the furnishings information server apparatus is characterized in that the server apparatus creates, as the furnishings-related information, benefit information for the target user based on the user information and outputs the benefit information to the user.

With this configuration, it is possible to obtain the result of information search by the user, purchase achievements and user attribute distribution, thus allowing analysis of the user's interest, popular furnishings and trend of consumption, thereby allowing effective market analysis and sales promotion activities.

The invention also provides a program used by a computer to execute a furnishings information management method according to any one of the aspects of the invention.

### BRIEF DESCRIPTION OF THE DRAWINGS

FIG. 1 is a block diagram showing the configuration of furnishings information server apparatus according to one embodiment of the invention;

FIG. 2 is a block diagram showing the first example of the operating form of the furnishings information server apparatus;

FIG. 3 is a block diagram showing the second example of the operating form of the furnishings information server apparatus;

FIG. 4 is a block diagram showing the third example of the operating form of the furnishings information server apparatus;

FIG. 5 shows a conceptual configuration example of a personal database storing user information;

FIG. 6 shows a functional configuration of the first embodiment of furnishings information server apparatus;

FIG. 7 shows an example of information flow in the configuration of the first embodiment;

FIG. 8 shows an example of information flow in the configuration of the first embodiment;

FIG. 9 shows an example of information flow in the configuration of the first embodiment;

FIG. 10 shows another example of information flow in the configuration of the first embodiment;

FIG. 11 shows an application example of coordination on a terminal;

FIG. 12 shows an example of a procedure used in case the coordination result is examined and the furnishings is purchased;

FIG. 13 shows application example of editing and providing catalog information on a per user basis;

FIG. 14 is a block diagram showing a functional configuration of the second embodiment of furnishings information server apparatus;

FIG. 15 shows an application example used in case desired information is selected from information provided by a plurality of magazines;

FIG. 16 shows an application example used in case coordination examination is made using furnishings information carried by a plurality of magazines.

In the figures, a numeral 11 represents a network, 12 a management server, 13 an apparel maker database, 14 a magazine database, 15 a shop database, 16 a personal database, 17 a settlement server, 20 a terminal, 51 an information pileup server, 52, 73 information sorting servers, 53, 74 information provision servers, 71 a magazine information server, and 72 a maker information server.

### BEST MODE FOR CARRYING OUT THE INVENTION

Embodiment of the invention will be described referring to drawings.

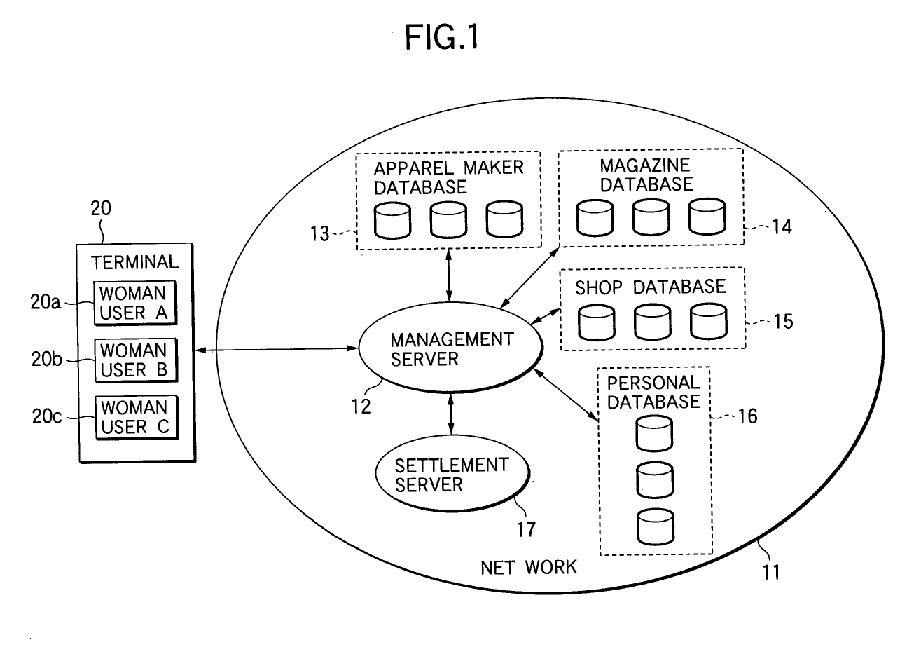

A general configuration of an embodiment of the invention is shown in FIG. 1. FIG. 1 is a block diagram showing the configuration of furnishings information server apparatus.

On the network 11 is provided a management server 12 having the function as an information management section for managing furnishings information. To this management server 12 are connected an apparel maker database 13, magazine database 14, shop database 15, and personal database 16. Into the apparel maker database 13 is stored provided information related to furnishings supplied from apparel makers manufacturing and supplying furnishings. Into the magazine database 14 is stored provided information related to furnishings carried by books such as magazines from publishers. Into the shop database 15 is stored provided information related to furnishings handled by shops selling furnishings. Into the personal database 16 is stored provided information related to furnishings owned by each user and user information including the user's body shape, age, and taste. In this case, the apparel maker database 13, magazine database 14 and shop database 15 correspond to a provided information storage section and the personal database 16 corresponds to a user information storage section.

A settlement server 17 is provided having the function of a purchase settlement section for making settlements for purchasing furnishings via the network 11 and is connected to the management server 12. The management server 12 is also connected to a terminal 20 used for operation and input and confirmation of screen display via the network 11. In FIG. 1, user terminals used by users A, B, C (all women) 20a, 20b, 20c are shown. It is assumed that the furnishings includes what the user mainly wears, such as tops and bottoms of clothes, underwear, shoes, hats, accessories, bags and other small articles.

The network 11 maybe a wide area network such as the Internet, and various wired or wireless communications means such as a communications network, telephone network and LAN. Communications means connecting the network 11 and the terminal 20 may be various wired or wireless communications interfaces using a telephone network or communications network. The terminal 20 operated by the user may be a fixed terminal such as a personal computer (PC), or a portable terminal such as a laptop PC, Personal Digital Assistant (PDA) or a cell phone. A terminal installed in a shop may also be used. Such communication means or a server, database or terminal implements a predetermined function by using a computer and its peripherals, so that the hardware configuration is not limited but may be configured as required depending on the use environment.

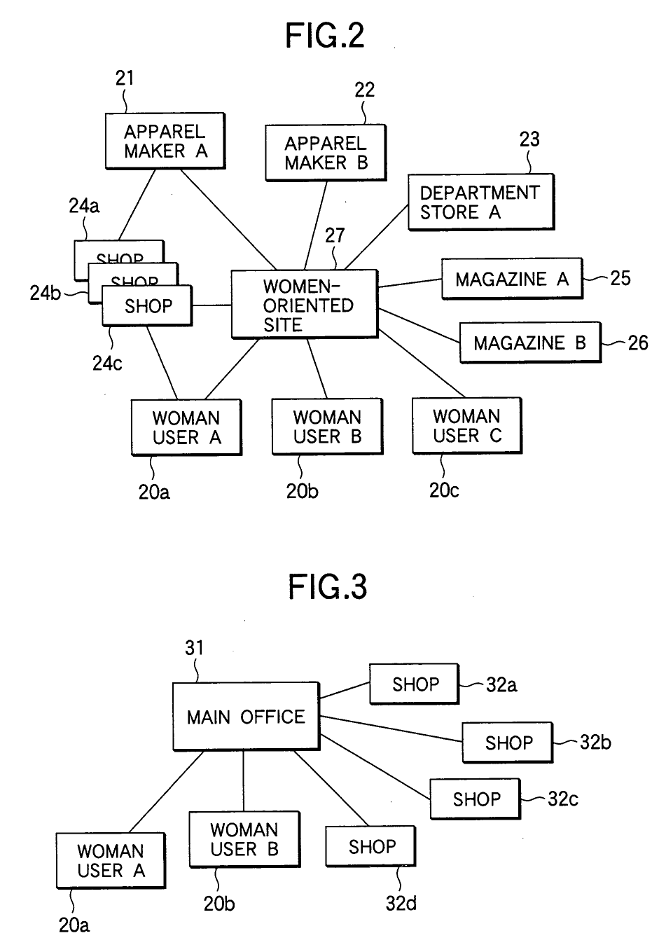

Examples of the operating form of the furnishings information server apparatus are shown in FIGS. 2 through 4. The first example shown in FIG. 2 is a form operated mainly by a women-oriented site 27 provided on the Internet. The women-oriented site 27 provides information on furnishings and other topics mainly specialized for women, including information earnestly needed by women and information beneficial to women. In this operating form, the women-oriented site 27 is composed of a management server 12 provided on an arbitrary network.

Furnishings information provided by Apparel Maker A 21 and Apparel Maker B 22 as apparel makers, furnishings information provided by Department Store A 23 and shops 24a through 24c as shops, and furnishings information provided by Magazine A 25 and Magazine B 26 as books carrying furnishings information are stored as provided information into the apparel maker database 13, shop database 15, and magazine database 14, respectively. On the women-oriented site 27, provided information on these furnishings is presented to the users 20a through 20c. The management server 12 performs input/output, storage and read processing of respective information and outputs desired information on furnishings to each user and information provider.

The users 20a through 20c browse the provided information arbitrarily and sequentially on the women-oriented site 27 or enter a keyword to search through the provided information to obtain desired furnishings information as furnishings-related information. It is also possible to examine the purchase of the furnishings or order or purchase the furnishings online, referring to the furnishings information obtained.

Information on furnishings owned by the users 20a through 20c, and personal information such as the user's body shape, age and taste are entered via the women-oriented site 27 and stored into the personal database 16 as user information. Such user information may be used by the user as auxiliary data for upgrading the search accuracy obtained when the user searches for desired furnishings information, or by the information provider to analyze the consumer trend and as reference data for future furnishings manufacturing, purchase, sales, stock management and/or preparing a magazine issue.

In this case, the user can reference furnishings information as integrated information from a plurality of information sources such as apparel makers, shops and magazines. The user can also compare information from a plurality of sources of a same category so that the user can easily and properly obtain desired furnishings information. Further, the user can easily obtain furnishings information based on the classification of furnishings information, without considering the actual information sources.

The second example shown in FIG. 3 is a form operated mainly by apparel makers. In this example, the apparel makers operate a furnishings information server by using their own networks or a general network such as the Internet. In this operating form, the furnishings information server is composed of a management server 12 provided in a main office 31. Furnishings information provided by the main office 31 of the apparel maker is stored into the apparel maker database 13 as provided information. Furnishings information provided by directly managed shops or other shops 321 through 32d dealing in the furnishings of the brand of the apparel maker is stored into the shop database 13 as provided information. The provided information on these furnishings is presented by the furnishings information server in them a in office 31. The management server 12 performs input/output, storage and read processing of respective information and outputs desired information on furnishings to each user and information provider.

Users 20a, 20b access the furnishings information server in the main office 31 via a network to obtain desired furnishings information as furnishings-related information. Information on furnishings owned by the users 20a, 20b and personal information such as the user's body shape, age and taste are entered via a network and stored into the personal database 16 as user information.

In this case, the user can directly obtain desired furnishings information from apparel makers or shops. The user can also obtain information on nearby shops or shops having a stock of target furnishings. An apparel maker or a shop can manage the users of its own brand and provide information on a per user basis, including information on the recommends and bargain information in the current season.

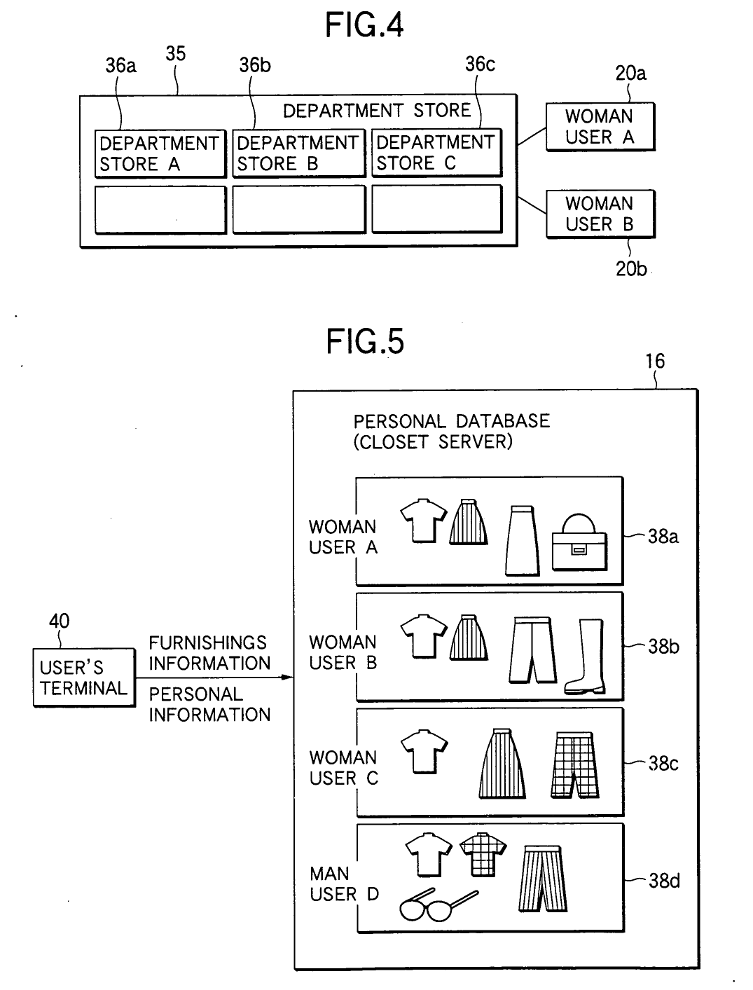

The third example shown in FIG. 4 is a form mainly operated by department stores or shopping centers having a plurality of shops. In this example, the department stores or shopping centers use their own networks or a general network such as the Internet to manage the furnishings information server. In this operating form, the furnishings information server is composed of a management server 12 provided in the department store 35. The department store 35 has a plurality of shops including Shop A 36a, Shop B 36b, Shop C 36c, . . . and furnishings information provided by the department store 35 itself or associated shops 36a through 36c is stored into the shop database 15 as provided information. The provided information on these furnishings is presented by the furnishings information server in the department store 35. The management server 12 performs input/output, storage and read processing of respective information and outputs desired information on furnishings to each user and information provider.

Users 20a, 20b access the furnishings information server in the main office 31 via a network to obtain desired furnishings information as furnishings-related information. Information on furnishings owned by the users 20a, 20b and personal information such as the user's body shape, age and taste are entered via a network and stored into the personal database 16 as user information.

In this case, the user can directly obtain desired furnishings information from apparel makers or shops. The user can also obtain information on nearby shops or shops having a stock of target furnishings. A department store or a shop can manage the users of the department store/shop and provide information on a per user basis, including information on the recommends and bargain information in the current season.

Next, a conceptual configuration example of a personal database storing user information is shown in FIG. 5. The personal database 16 comprises data areas for individual users and into each area is stored user information. In the example of FIG. 5, data areas 38a through 38d for women users A, B, C and a male user D respectively are shown. Into the data areas 38a through 38d is stored information on the furnishings owned by each user and purchased by each user. The furnishings information includes the data (information on the user's own furnishings) representing the item name, color, shape, size and design group, as well as the image data of the furnishings.

As image data of furnishings, digital data of furnishings images obtained using for example a camera is modified as required and is input. Or, image data may be created using the computer graphics (CG). The furnishings data may be represented in three-dimensional data. Although not shown, it is possible to store information such as the body shape of the user including the height and weight, taste of furnishings such as favorite color of clothes and design group, age, and furnishings purchase history. User information such as information on the user's own furnishings and personal information is entered from the user terminal 40 of a personal computer. In case the user has purchased furnishings whose information was provided by using the system, the provided furnishings information should be stored as information on the user's own furnishings.

The personal database 16 serves as a user-based closet server. Each user can access the personal database 16 by using a terminal such as a Personal Digital Assistant (PDA) or a cell phone, or from a terminal provided in a shop thereby extracting information on the user's own furnishings, irrespective of the location of the user, for example a location except the home or a remote location. This provides an electronic portable-type mobile closet. In case the user accesses the information stored in the personal database 16, an authentication key or password is used for authentication thus assuring security.

The following describes more specific embodiments of furnishings information server apparatus. Procedures including input/output, transmission/reception, information processing and information management of furnishings information by using the furnishings information server apparatus in this embodiment serve as a furnishings information management method.

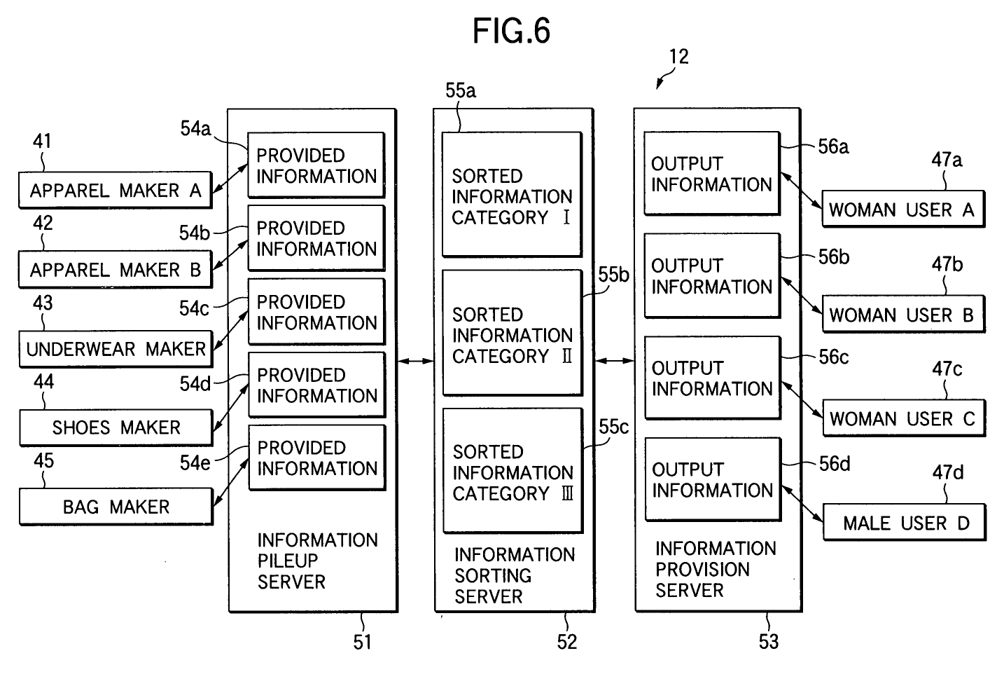

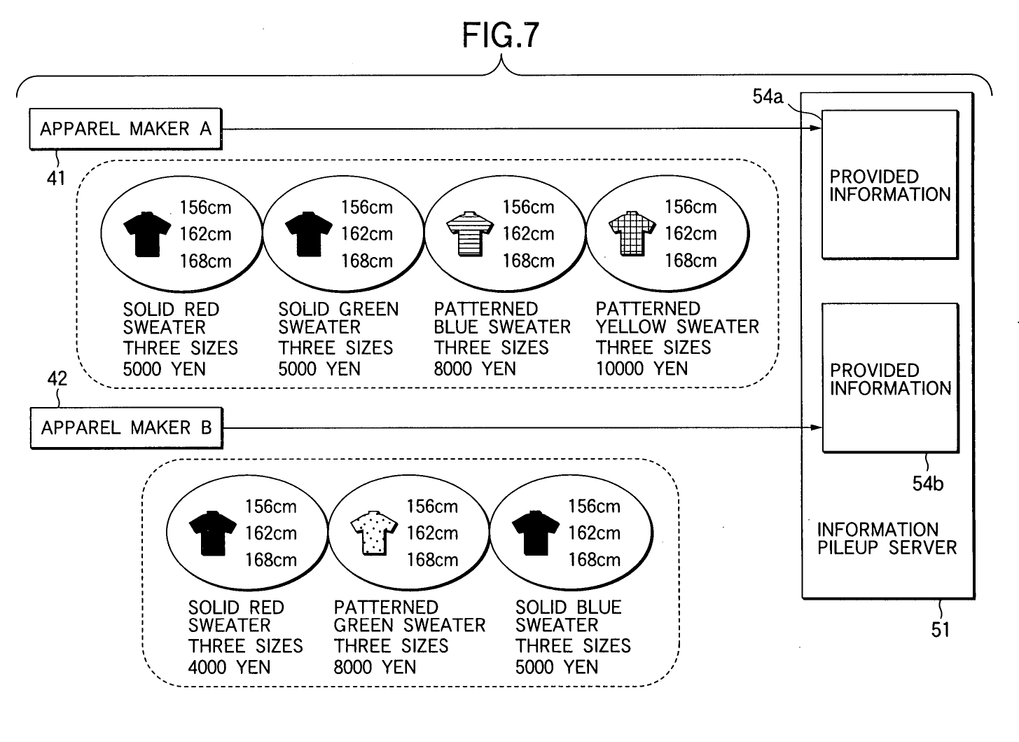

FIG. 6 is a block diagram showing a functional configuration of the first embodiment. The management server 12 for managing furnishings information shown in FIG. 1 has an information pileup server 51, an information sorting server 52, and a information provision server 53, which perform separate functions. The servers 51 through 53 may be configured by a plurality of servers or a single server may perform a plurality of functions. The hardware configuration may be arbitrarily configured depending on the use environment.

Into the information pileup server 51, provided information on furnishings from Apparel Maker A 41, Apparel Maker B 42, an underwear maker 43, a shoes maker 44, and a bag maker 45 is stored. In this example, data areas are provided per information source and provided information is stored into the data areas 54a through 54e. The provided information includes the data (provided furnishings information) representing the item name, color, shape, size and design group, as well as the image data of the furnishings. The price, supply source and stock state of the furnishings may be stored as well. The provided information such as the provided furnishings information may be entered in the same way as the aforementioned user information.

Provided information stored in the information pileup server 51 is classified and sorted by category of furnishings in the information sorting server 52 and stored as sorting information. For example, the information is stored into the data areas 55a through 55c for categories I through III, sorted by type (by item) such as jackets, overcoats, sweaters, skirts and shirts. Then, necessary information is extracted from this sorting information in the information provision server 53 in a search processing to generate furnishings-related information. This information is sent as output information to the terminals of the users 47a through 47d. In this example, output information is temporarily stored into the data areas 56a through 56d provided per user.

While the databases 13 through 16 shown in FIG. 1 for storing provided information related to furnishings and user information are not shown in this example, these databases are provided inside or outside of the server.

An example of information flow in the configuration of FIG. 6 will be explained using FIGS. 7 through 9. Here, information of sweaters is shown as an example of furnishings. As shown in FIG. 7,n information on sweaters to be provided as articles is sent from Apparel Maker A 41 and Apparel Maker B 42 and respectively stored into the data areas 54a, 54b by information source on the information pileup server 51. Sweater information includes the features of color and pattern, size and price.

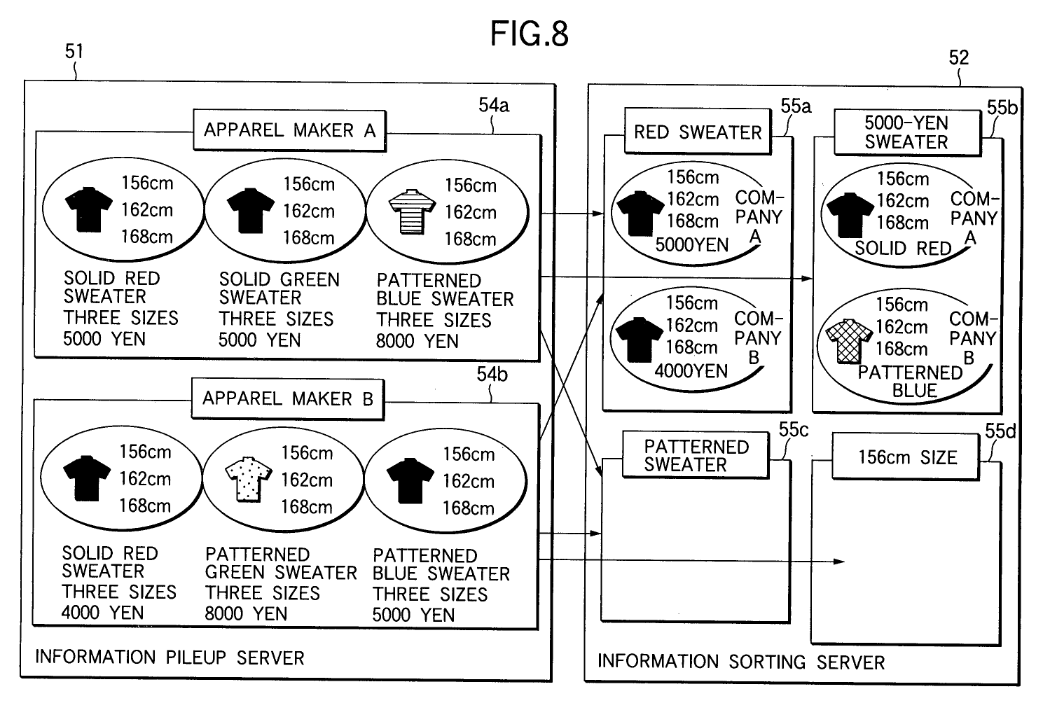

Next, as shown in FIG. 8, sweater information stored into the data areas 54a, 54b of the information pileup server 51 is classified by category in the information sorting server 52 and stored into respective data areas 55a through 55d. For example, information is sorted through categorization using a keyword used by the user to search for target information, such as the color, price, pattern and size. Such information sorting is made prior to registration to boost the information search processing. In case a sufficient speed is obtained in operation, information matching a search keyword entered as required may be extracted from the information of the information pileup server 51 for categorization. Information matching more than one category is stored into corresponding data areas 55a through 55d in an overlapped way.

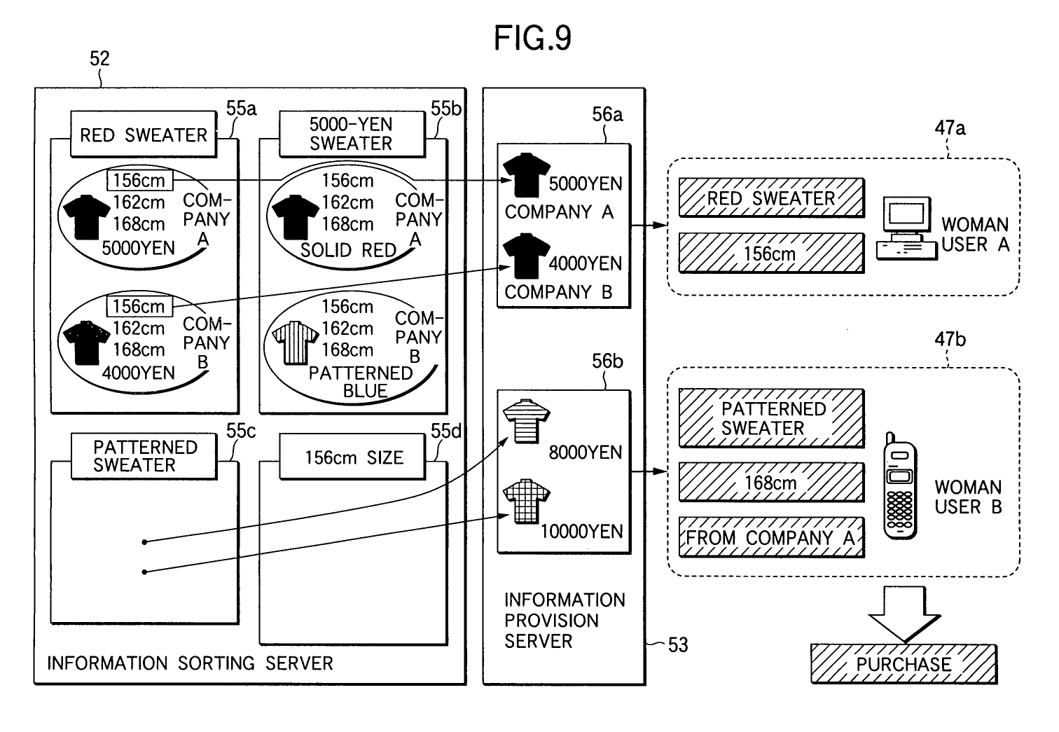

As shown in FIG. 9, when the users 47a, 47b access the management server 12 from terminals and enter a keyword for information search, information matching the entered keyword is extracted from the information stored by category into the information sorting server 52 and stored into the user-based data areas 56a, 56b in the information provision server 53.

The extracted information is respectively sent to the terminals of the users 47a, 47b and displayed on the display screen. In the example of FIG. 9, User A (woman) requests the information of “Red sweater” and “156 cm” while User B (woman) requests the information of “patterned sweater”, “168 cm” and “from Company A”. The user 47a, 47b checks the obtained information and selects a target article or makes an online purchase or online reservation order if wishing to purchase it, or otherwise obtains information on the shops selling the article. various processing in purchasing furnishings will be described later.

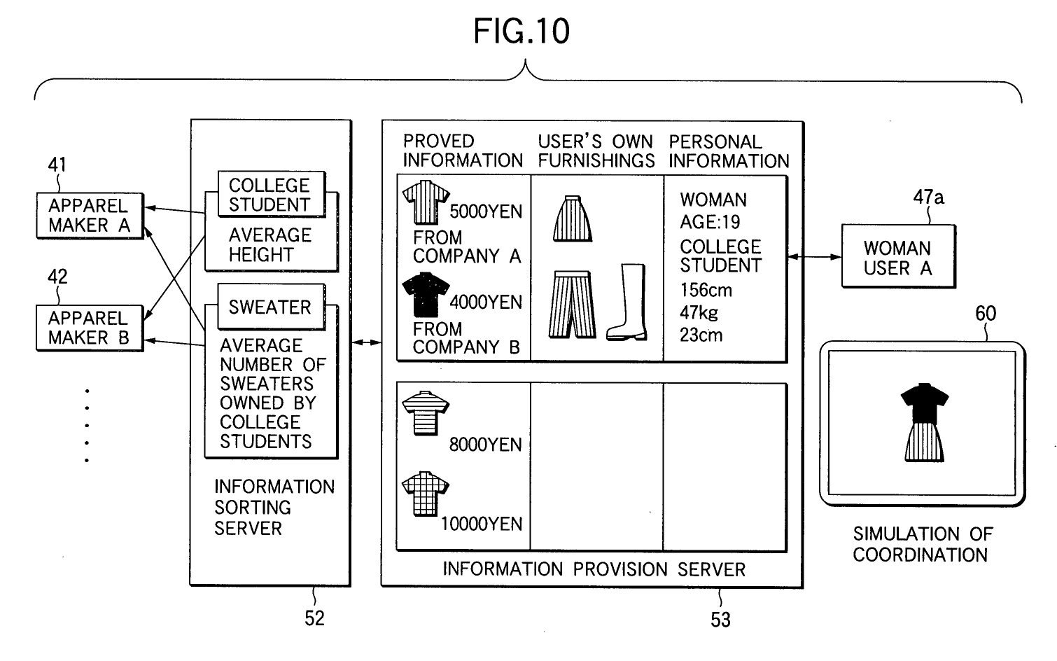

Another example of information flow in the configuration of FIG. 6 is shown in FIG. 10. FIG. 10 shows the flow of information used when user information is provided to an apparel maker as an furnishings supply source. From the information provision server 53, information is sent from provided furnishings information from Apparel Maker A 41 and Apparel Maker B 42 in response to a user's request, as mentioned earlier. Into the information provision server 53 is stored user information on each user. The user information includes information on the furnishings owned by each user as information on the user's own furnishings, and user-based closets are formed on the server. Further, information indicating personal features referenced in selection and purchase of furnishings, such as sex, age, height, weight and size of shoes, is stored as personal information.

Into the information sorting server 52, user information is also categorized and stored together with provided information on furnishings provided by an aforementioned apparel maker. In the example of FIG. 10, user characteristics information such as the average height of college students and average number of user's own sweaters is stored based on the user information classified into categories including “college student” and “sweater”.

Such user characteristics information is sent to an apparel maker as a furnishings supply source and utilized as marketing data. For example, such data is used to analyze and examine the features and trend of taste of the users of the maker's brand or used as a reference to future lineup development so as to supply furnishings matching the user's needs. Information such as s keyword used by the use in an information search or number of online purchases/reservation orders may be utilized as user information. Further, registered users may be provided with benefit information and membership benefit for sales promotion activities. Care is exercised so that extra information such as the user's name to help identify the individual user will not be sent to an information source. In case an information source accesses the user information, an authentication key or password is used for authentication thus assuring security.

On a terminal 60, the user can simulate coordination of information-provided furnishings or user'sown furnishings and information-provided furnishings.

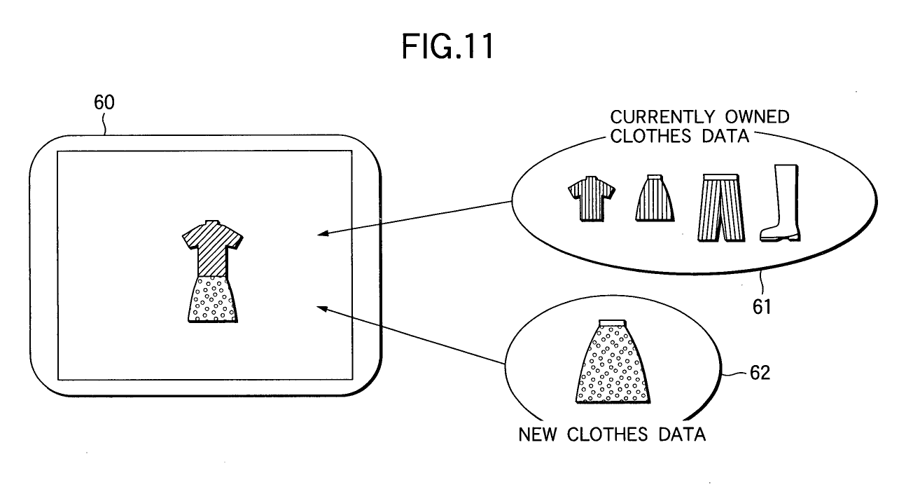

An application of coordination on a terminal in this embodiment will be described using FIG. 11. Currently owned clothes data 61 stored as information on the user's own furnishings and new clothes data 62 stored as provided furnishings information are sent and synthesized and displayed as coordination information comprising a combination of furnishings images on the display screen of the terminal 60. In this practice, body shape data and face image data of the user are used to create a user's image on the coordination screen, on which is overlaid images of furnishings. Such a representation is preferable because it is more real and effective. Image information is sent to the terminal 60 through control processing by the management server to form coordination information on the coordination screen.

This makes it possible to easily check a combination of various clothes via simulation in an attempt to find furnishings matching the currently owned furnishings of the user or to examine coordination of furnishings. In case the user purchases new clothes, the user can examine coordination by way of the provided furnishings information and purchase the matching items at a time.

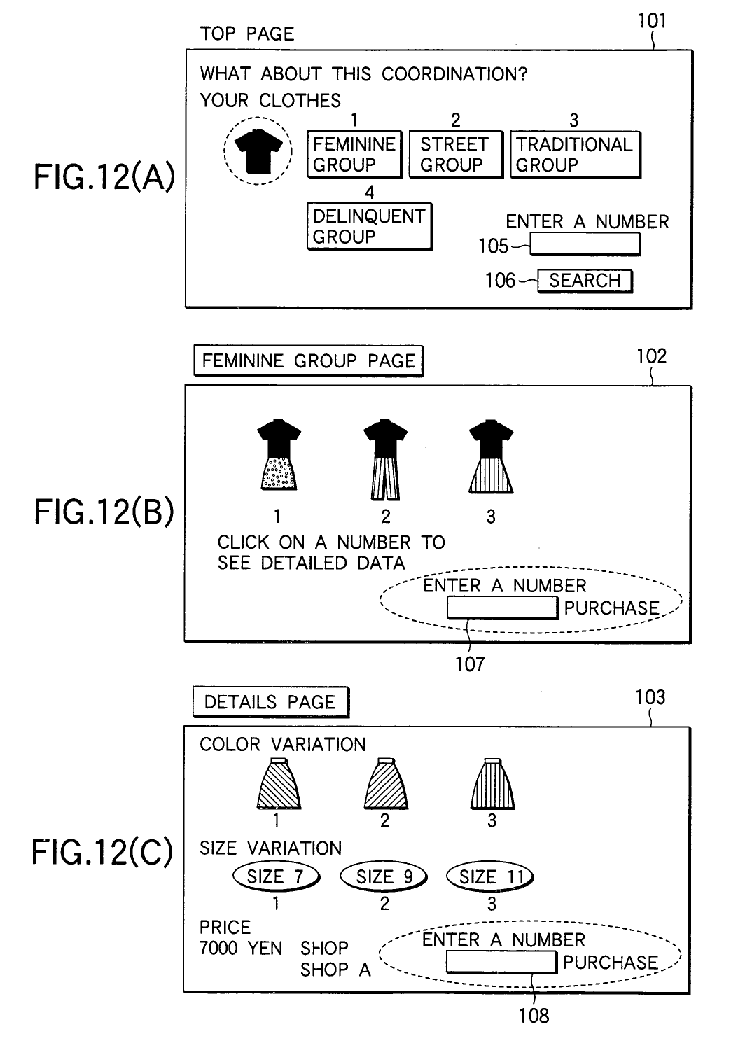

An example of procedure used when the user checks the coordination result on the terminal and makes a purchase is shown in FIG. 12. On the top page 101 for coordination shown in FIG. 12(A), images of items as a base for coordination from the information on the user's own furnishings are displayed. Beside the item images are displayed selections of design group such as “Feminine group” and “Street group”. The user enters the number of his/her favorite design group in the input area 105 in the lower right corner or selects the item of that design group by using a cursor or touching the item with his/her finger, then clicks on the search button 106 to instruct start of coordination. The screen switches to a coordination page 102 shown in FIG. 12(B). This example assumes that “Feminine group” is selected.

In the coordination page 102 shown in FIG. 12(B), for example, three types of coordination results are displayed as candidates. To produce coordination results, it is possible to store in advance arrangements where colors, patterns and designs are matching with each other or obtain numerical values through operation of relative values concerning a design. In case the user likes one of the candidates of coordination result, the user can enter the coordination number or select the item of that coordination by using a cursor or touching the item with his/her finger. Then the screen switches to a details page 103 shown in FIG. 12(C).

In the details page 103, color variations, size variations, prices and corresponding shops are displayed concerning the mating item of coordination selected. For sizes, it is possible to extract matching items in advance referring to the user information. The user wishing to make a purchase enters an article number in the input area 108 in the lower right corner or selects the article item by using a cursor or touching the item with his/her finger to proceed to the purchase procedure for the furnishings. It is possible to make a reservation order as well as a purchase. The user can go to a shop dealing in the furnishings to actually check the article.

In the purchase procedure, settlement processing necessary for a purchase of articles is made by the settlement server 17 shown in FIG. 1, such as online settlement of e-money and settlement byway of a credit card. To the settlement server 17, only information necessary for settlement is sent from the management server 14. Extra information on privacy such as information on the user's own furnishings in the closet is not sent.

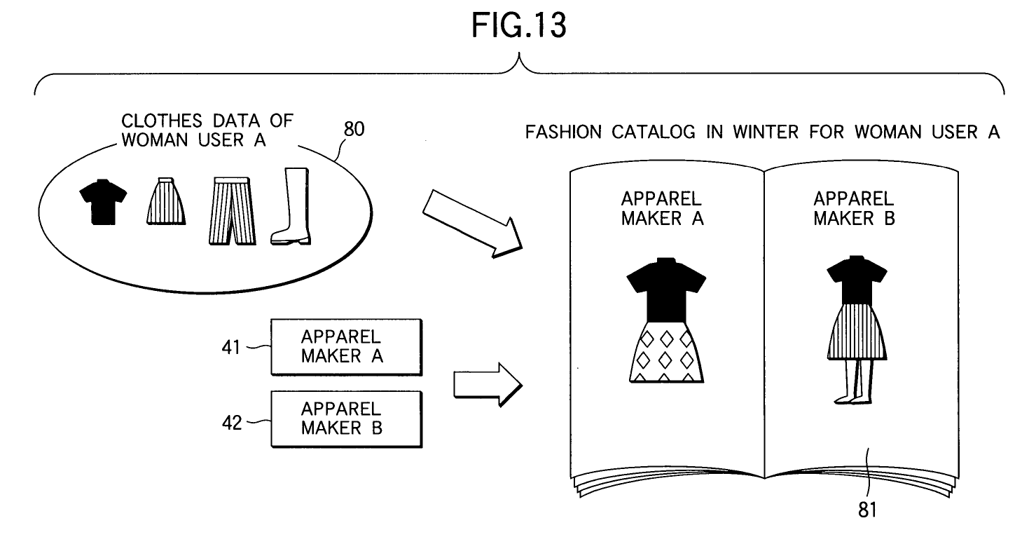

An application used when catalog information is edited and provided per user in this embodiment will be described using FIG. 13. Currently owned clothes data 80 stored per user as information on the user's own furnishings and other user information are referenced to extract recommended furnishings information fitting the user's taste and body shape from the provided furnishings information such as Apparel Maker A 41 and Apparel Maker B 42 to create catalog information 81. The catalog information 81 can be browsed on the user's terminal. In this practice, it is possible to separately provide catalog information per furnishings supply source or integrate information from the furnishings supply sources into catalog information. It is also possible to provide catalog information in linkage with information carried by a magazine. The catalog information is sent to the user's terminal through control processing by the management server 12 to form a catalog on the display screen.

Same as the catalog information, it is possible to utilize user information and create and provide bargain information and new products information customized per user. Further, registered users may be provided with membership benefit via benefit information such as discount.

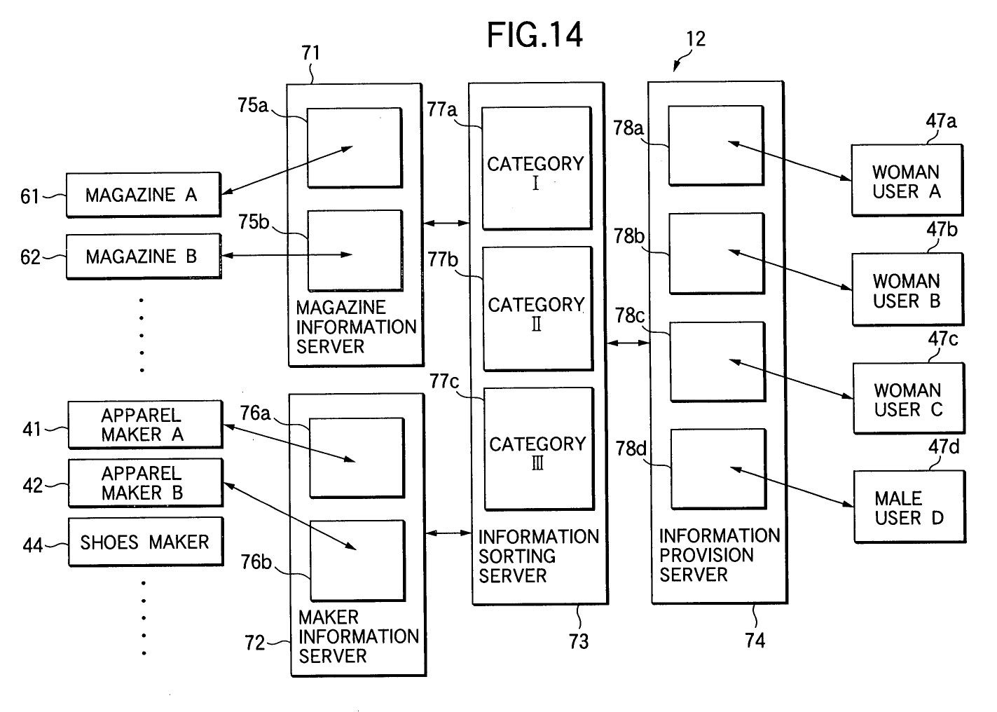

FIG. 14 is a block showing a functional configuration of the second embodiment. In the second embodiment, the management server 12 for managing furnishings information has a magazine information server 71, a maker information server 72, an information sorting server 73, and information provision server 74, which perform separate functions. The servers 71 through 74 maybe configured by a plurality of servers or a single server may perform a plurality of functions. The hardware configuration may be arbitrarily configured depending on the use environment. The second configuration allows integration of information provided by a plurality of magazines or integration of information provided by magazines and information provided by furnishings supply sources such as apparel makers to provide the user with sorted furnishings-related information.

Into the magazine information server 71, provided information on furnishings carried on printed materials such as Magazine A 61, Magazine B 62 or online electronic books is stored without modification. To the maker information server 72, similar to the information pileup server 51, provided information on furnishings from Apparel Maker A 41, Apparel Maker B 42, an under wear maker 43, and a shoes maker 44 is stored without modification. In the magazine information server 71 and the maker information server 72, data areas are provided per information source and provided information is stored into the data areas 75a, 75b, 76a and 76b. The magazine information server 71 and the maker information server 72 may be integrated into an information pileup server 51, as shown in the first embodiment.

Provided information stored in the magazine information server 71 and the maker information server 72 is classified and sorted by category of furnishings in the information sorting server 73 and stored as sorting information. For example, the information is stored into the data areas 77a through 77c for categories I through III, sorted by type of furnishings. Then, necessary information is extracted from this sorting information in the information provision server 74 in a search processing. This information is sent as output information to the terminals of the users 47a through 47d from the data areas 78a through 78d. Contents and flow of information exchanged and stored in the second embodiment are almost the same as those in the first embodiment so that detailed description is omitted.

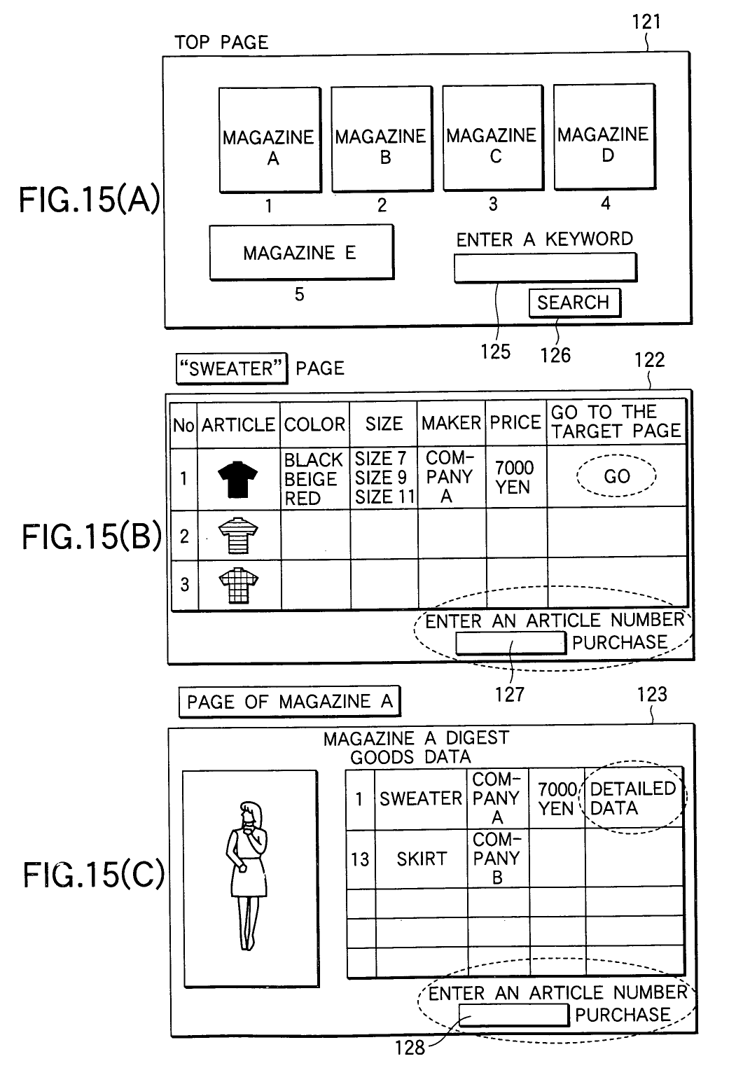

An application of selecting desired information from provided information on a plurality of magazines in this embodiment will be described using FIG. 15. On the top page 121 of magazine browsing shown in FIG. 15(A), names and coversheets of the magazines are displayed side by side. The user enters the keyword for a target item, name and number of a magazine in the input area 105 in the lower right corner then clicks on the search button 106 to instruct start of information browsing. The screen switches to a page carrying the corresponding information.

FIG. 15(B) is an item information page 122 indicating the information of “sweater”. In this page, furnishings information extracted by the keyword “sweater” from a large quantity of furnishings information carried by a plurality of magazines is displayed side by side for example in a table format. In the example of the figure are shown the image, color, size, maker and price of each item of furnishings. Clicking on the column “Go to the target page.” moves to a page of a magazine carrying the furnishings information or a page carrying detailed information. The user wishing to make a purchase enters an article number in the input area 127 in the lower right corner or selects the article item by using a cursor or touching the item with his/her finger to proceed to the purchase procedure for the furnishings.

FIG. 15(C) is a magazine information page 123 indicating the information of “Magazine A”. In this page, concerning furnishings information carried by “Magazine A” selected from a plurality of magazines, item information is displayed side by side in a table format, along with the coordination images of models. In the example of the figure are shown the maker and price of each item of furnishings. Clicking on the column “Detailed data” on the right most are a moves to the page of detailed information on the article or furnishings information on the item (for example sweater). The user wishing to make a purchase enters an article number in the input area 128 in the lower right corner or selects the article item by using a cursor or touching the item with his/her finger to proceed to the purchase procedure for the furnishings. In this embodiment also, it is possible to make reservation order as well as make an online purchase.

Only the summary of the information carried by a magazine may be disclosed to public except the information on the furnishings to be purchased. Detailed article information may be separately purchased or may be browsed only buy a purchaser of the furnishings.

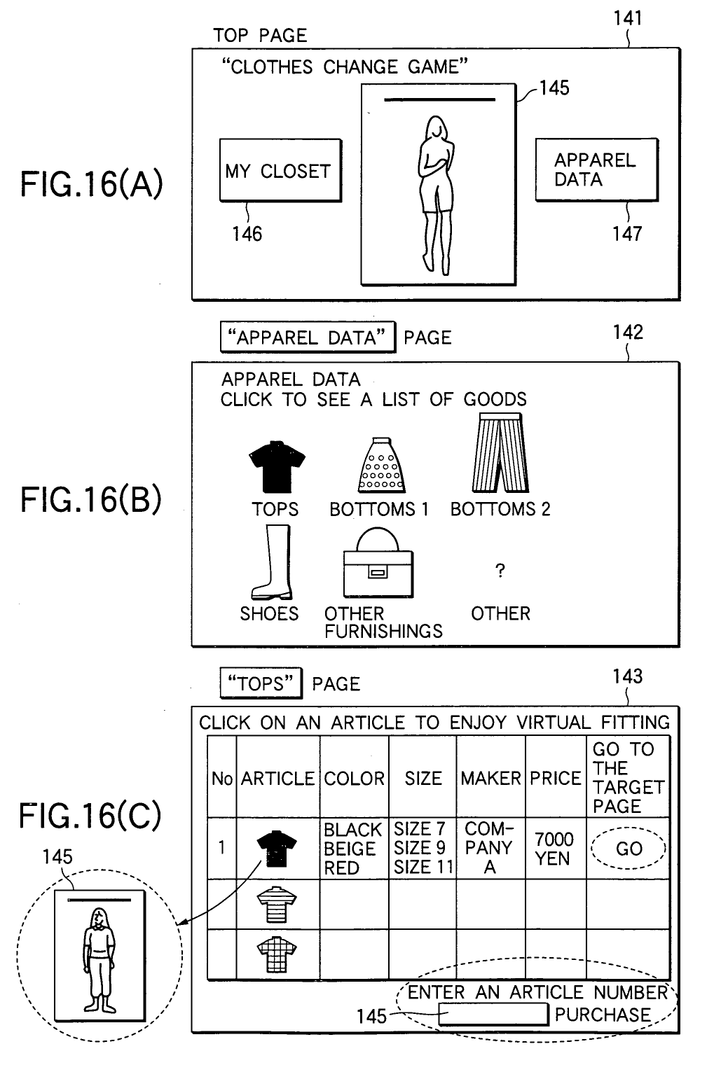

Another application of this embodiment for examining coordination using furnishings information carried by a plurality of magazines will be described referring to FIG. 16. In a top page 141 for examination of coordination, a coordination display area 145 is provided. In order to search for furnishings information as materials for coordination, a My Closet button 14 6 and an apparel data button 147 are displayed. Clicking on the My Closet button 146 moves to a page displaying the information on the user's own furnishings. Clicking on the apparel data button 147 moves to a page displaying information provided by apparel makers.

FIG. 16(B) is an apparel data page indicating information provided by apparel makers. In this page, for example, selections are displayed side by side. In the example of the figure are shown tops, bottoms 1, bottoms 2 and shoes. The user picks up a desired selection by using a cursor or touching the item with his/her finger, then the screen switches to a item list page 143 shown in FIG. 16(C). This example assumes that “Tops” is selected.

In the item list page 143 in FIG. 16(C), furnishings information that belongs to tops is arranged for example in the table format. In the example of the figure are shown the image, color, size, maker and price of each item of furnishings. Clicking on the column “Go to the target page.” in the rightmost area moves to a page of an apparel maker or a magazine carrying the furnishings information. The user wishing to make a purchase enters an article number in the input area 145 in the lower right corner or selects the article item by using a cursor or touching the item with his/her finger to proceed to the purchase procedure for the furnishings. it is also possible to make reservation order as well as make an online purchase.

When the user selects the item of desired furnishings item by using a cursor or touching the item with his/her finger, the screen switches to a top page 141 where the selected furnishings are displayed in a coordination display area 145. When wishing to coordinate user's own items, the user selects the My Closet button 146 to move to a user data page (not shown) where the user selects favorite furnishings. The user data page has almost the same configuration as the apparel data page 142.

By repeating the aforementioned selection procedure, it is possible to arbitrarily change the combination of coordination of furnishings on the screen of a terminal. This allows the user to make virtual clothes change on the terminal to facilitate examination of coordination.

In this way, in the embodiment, furnishings information provided by a plurality of information sources including apparel makers, shops, and books such as magazines is stored into databases. The user can easily obtain desired furnishings information from a plurality of information sources by specifying a keyword for an item. Magazine information and information from apparel makers and shops may be shared in mutual relation so that the user can easily obtain target information and purchase furnishings while apparel makers and shops can make more effective sales promotion activities.

By storing information on the user's own furnishings and personal information of the user into databases and combining such user information with furnishings information provided by apparel makers, shops and books such as magazines it is possible for the user to easily check an arbitrary coordination of furnishings such as an arbitrary combination of information-provided furnishings and a combination of user's own furnishings and information-provided furnishings depending on the user's state, in collecting furnishings information, examining a purchase or examining coordination of furnishings. The user can also record the history of combinations of furnishings the user actually wore in order to carry out coordination schedule management. The user can manage information on the furnishings of a plurality of persons including his/her family members such as his/her spouse and children, as well as his/her own furnishings.

It is possible for the user to manage ii on the user's own furnishings by using a user information database so that it is possible to examine coordination and check for duplicated purchases before purchasing furnishings thus reducing failure in purchasing furnishings.

The information provider can provide information customized as required on a per user basis or propose coordination of furnishings thus providing the user with proper information as required. It is also possible to analyze the user's interest, popular furnishings and consumption trend by using the information research result and purchase achievements as well as user attribute analysis, thereby performing effective market analysis and sales promotion activities.

In this way, according to this embodiment, it is possible to integrate management of information on the user's own furnishings and furnishings information provided by apparel makers, shops, and books such as magazines and easily obtain and effectively provide furnishings-related information. This approach allows both the user and the information provider to communicate useful information.

While the invention has been described in details referring to specific embodiments, those skilled in the art will understand that various changes and variations may be made without departing from the spirit and scope of the invention.

This application is based on the Japanese patent application filed Mar. 23, 2001 (Japanese Patent Application No. 2001-086043), which is incorporated herein by reference.

Industrial Applicability

As mentioned earlier, according to the invention, it is possible to provide furnishings information server apparatus and a furnishings information management method where by the user can easily obtain the information on the desired furnishings from a plurality of information sources by specifying the keyword of an item.

It is also possible to provide furnishings information server apparatus and a furnishings information management method whereby the user can examine the coordination such as an arbitrary combination of furnishings whose information is provided by apparel makers, shops and books or a combination of the user's own furnishings and furnishings whose information is provided.

It is also possible to provide furnishings information server apparatus and a furnishings information management method whereby the user can manage the information on the currently owned furnishings of the user and the user's own personal information and obtain proper information in order to reduce failure in purchasing furnishings.

It is also possible to provide furnishings information server apparatus and a furnishings information management method whereby the information provider can provide information customized as required on a per user's basis or propose coordination by acquiring the user's personal information, thereby allowing effective market analysis and sales promotion activities.

1. Furnishings information server apparatus comprising:
a provided information storage section for storing provided information including information on furnishings provided by at least one of the apparel maker supplying furnishings on to the market, shop selling furnishings, and book carrying information on furnishings;
a user information storage section for storing user information including information on the user'sown furnishings; and
an information management section for outputting furnishings-related information in response to a request from the user or information provider based on said provided information and said user information.

2. Furnishings information server apparatus according to claim 1, wherein said user information includes information on the user's own furnishings representing features of furnishings including at least one of the item name, color, shape, size and design group, as well as the images of the user's own furnishings.

3. Furnishings information server apparatus according to claim 2, wherein said user information includes personal information including at least one of the body shape, taste, age and furnishings purchase history of said user.

4. Furnishings information server apparatus according to claim 1, wherein said provided information includes provided furnishings information representing features of furnishings including at least one of the item name, color, shape, size and design group, as well as the images of the furnishings provided by the information provider.

5. Furnishings information server apparatus according to claim 4, wherein said provided information further includes furnishings purchase information including at least one of the price of the furnishings, furnishings supply source, stock state, and information such as catalogs from the information source provided by said information provider.

6. Furnishings information server apparatus according to claim 1, wherein furnishings coordination information including a combination of information on the user's own furnishings in said user information, information on the furnishings provided by the information provided in said provided information and both information on the furnishings is created as said furnishings-related information, and the furnishings coordination information is output in response to a request from the user or information provider.

7. Furnishings information server apparatus according to claim 6, wherein said coordination information is created by extracting and combining furnishings which fit the target user based on the personal information including the taste of said user.

8. Furnishings information server apparatus according to claim 6, wherein said coordination information is variably created by using a combination of furnishings in accordance with the instruction input of said user or information provider.

9. Furnishings information server apparatus according to claim 6, wherein said coordination information is created by extracting and combining furnishings from said provided information provided by a plurality of information providers.

10. Furnishings information server apparatus according to claim 1, wherein catalog information related to furnishings in said provided information provided by the information provider is created as said furnishings-related information, and said catalog information is output in response to a request from the user or information provider.

11. Furnishings information server apparatus according to claim 10, wherein said catalog information is created by extracting furnishings which fit the target user based on the personal information including the taste of said user.

12. Furnishings information server apparatus according to claim 10, wherein said catalog information is created by combining said provided information provided by a plurality of information providers.

13. Furnishings information server apparatus according to claim 1, further comprising a purchase settlement section for performing settlement on the purchase of the corresponding furnishings in accordance with the instruction input from the user executed concerning said furnishings-related information.

14. Furnishings information server apparatus according to claim 1, wherein user characteristics information on the user's own furnishings or furnishings to be purchased based on said user information is created as said furnishings-related information, and said user characteristics information is output to the information provider.

15. Furnishings information server apparatus according to claim 1, wherein benefit information for the target user based on said user information is created as said furnishings-related information, and said benefit information is output to the user.

16. A furnishings information management method comprising the steps of:
a provided information storing step for storing provided information including information on furnishings provided by at least one of the apparel maker supplying furnishings onto the market, shop selling furnishings, and book carrying information on furnishings;
a user information storing step for storing user information including information on the user's own furnishings; and
an information management step for outputting furnishings-related information in response to a request from the user or information provider based on said provided information and said user information.

17. A furnishings information management method according to claim 16, wherein said user information includes information on the user's own furnishings representing features of furnishings including at least one of the item name, color, shape, size and design group, as well as the images of the user's own furnishings.

18. A furnishings information management method according to claim 17, wherein said user information includes personal information including at least one of the body shape, taste, age and furnishings purchase history of said user.

19. A furnishings information management method according to claim 16, wherein said provided information includes provided furnishings information representing features of furnishings including at least one of the item name, color, shape, size and design group, as well as the images of the furnishings provided by the information provider.

20. A furnishings information management method according to claim 19, wherein said provided information further includes furnishings purchase information including at least one of the price of the furnishings, furnishings supply source, stock state, and information such as catalogs from the information source provided by said information provider.

21. A furnishings information management method according to claim 16, wherein furnishings coordination information comprising a combination of information on the user's own furnishings in said user information, information on the furnishings provided by the information provided in said provided information and both information on the furnishings is created as said furnishings-related information, and the furnishings coordination information is output in response to a request from the user or information provider.

22. A furnishings information management method according to claim 21, wherein said coordination information is created by extracting and combining furnishings which fit the target user based on the personal information including the taste of said user.

23. A furnishings information management method according to claim 21, wherein said coordination information is variably created by using a combination of furnishings in accordance with the instruction input of said user or information provider.

24. A furnishings information management method according to claim 21, wherein said coordination information is created by extracting and combining furnishings from said provided information provided by a plurality of information providers.

25. A furnishings information management method according to claim 16, wherein catalog information related to furnishings in said provided information provided by the information provider is created as said furnishings-related information, and said catalog information is output in response to a request from the user or information provider.

26. A furnishings information management method according to claim 25, wherein said catalog information is created by extracting furnishings which fit the target user based on the personal information including the taste of said user.

27. A furnishings information management method according to claim 25, wherein said catalog information is created by combining said provided information provided by a plurality of information providers.

28. A furnishings information management method according to claim 16, further comprising a purchase settlement step for performing settlement on the purchase of the corresponding furnishings in accordance with the instruction input from the user executed concerning said furnishings-related information.

29. A furnishings information management method according to claim 16, wherein user characteristics information on the user's own furnishings or furnishings to be purchased based on said user information is created as said furnishings-related information, and said user characteristics information is output to the information provider.

30. A furnishings information management method according to claim 16, wherein benefit information for the target user based on said user information is created as said furnishings-related information, and said benefit information is output to the user.

31. A program used by a computer to execute a furnishings information management method according to any one of claims 16 through 30.
